(19) United States
(12) Patent Application Publication
(10) Pub. No.: US 2003/0035535 A1
(43) Pub. Date: Feb. 20, 2003

(54) Compact wall phone filter housing unit

(76) Inventors: Frederick J. Kiko, Carlsbad, CA (US); David B. Beene, Oceanside, CA (US); David Millar, Aliso Viego, CA (US)

Correspondence Address: Davis Chin, 16061 S. 94th Avenue, Orland Hills, IL, 60477-4623, US

(21) Appl. No.: 09/929,775

(22) Filed: Aug. 15, 2001

(51) Int. Cl. H04M 1/00; H04M 9/00

(52) U.S. Cl. 379/419; 379/435

(57) ABSTRACT

A wall phone filter housing unit adapted for interfacing between incoming telephone lines connected to a wall mounting plate and subscriber's network termination equipment is provided. The housing unit includes a base member, a cover member adapted for co-mating with the base member, and a PCB assembly having an impedance blocking filter mounted thereon disposed between the base member and the cover member. The housing unit further includes a first modular plug for connection to incoming telephone lines, a first filtered modular jack for connection to a telephone set, a second filtered modular jack for connection to an answering machine or Fax machine, and a third unfiltered modular jack for connection to DSL or HPN equipment devices.

### BACKGROUND OF THE INVENTION

This invention relates generally to impedance blocking filter circuits used in telecommunication systems. More particularly, it relates to a compact wall phone filter housing unit of a unique construction which is adapted for interfacing between incoming telephone lines connected to a wall telephone mounting plate and subscriber's or customer's network termination equipment.

In view of telephone technology of today, there are many telephone subscribers or customers that have a personal computer with a modem located on their premises. At times, the computer user desires to receive DSL (an acronym for Digital Subscriber Line) signals from the Internet over the same telephone lines via the modem which is connected to an Internet Service Provider (ISP) In order to increase the speed of downloading of information from the Internet, a DSL network interface is typically purchased and installed between the incoming telephone lines and the user's computer. However, since one or more telephone subscriber's network termination equipment such as telephone sets (including cordless types), answering machines, facsimile (FAX) machines, 56 kb/s and lower rate modems, automatic dialers, and recorder connectors are also connected to the same incoming telephone lines via internal house wiring, DSL interference problems may be caused by the network termination equipment which can significantly decrease data rates and/or can create attenuation loss, radiate noise and generate cross-talk.

Accordingly, it has now been necessary to install some type of impedance blocking filter circuit on all of the subscriber's network termination equipment including wall phones so as to eliminate any erratic changes in the input impedances thereof. Unfortunately, the phone jacks for the wall phones are usually located in small, tight spaces such as in kitchens, hallways, garages and the like where it is inconvenient to place a table top phone. Generally, a wall telephone mounting plate is used for mounting the wall phone and includes a central communication jack with a pair of vertically spaced-apart mounting posts. In order to install the wall phone, a plug in the back of the phone is initially aligned with the central jack in the mounting plate and is then pushed into the jack so as to make a connection. At the same time, the pair of mounting posts are received in holes in the back of the wall phone, and the phone is thereafter pulled downwardly so as to securely hold the same in place.

There are known in the prior art of filter adapters which have been designed so as to interface between the wall telephone mounting plate and the subscriber's equipment. However, they have all suffered from one or more disadvantages such as being large, bulky, expensive and/or difficulties in installation. Further, other prior art designs have the drawbacks of being unable to fit in applications where the wall phone jacks are too close to a counter or cabinet and/or being too costly for manufacturing due to all of the wiring required for the filter components.

In view of the foregoing problems encountered, there still exists a need for a wall phone filter housing unit which is of a compact construction, is relatively easy to install, and is economical to manufacture and assemble. The housing unit of the present invention is of a unique configuration which is comprised of a base member, a cover member adapted for co-mating with the base member, and a PCB assembly having an impedance blocking filter circuit mounted thereon disposed between the base member and the cover member.

### SUMMARY OF THE INVENTION

According, it is a general object of the present invention to provide a compact wall phone filter housing unit of a unique construction which is relatively simple and economical to manufacture and assemble.

It is an object of the present invention to provide a compact wall phone filter housing unit which is adapted for interfacing between incoming telephone lines connected to a wall telephone mounting plate and subscriber's or customer's network termination equipment.

It is another object of the present invention to provide a wall phone filter housing unit which is comprised of housing means for receiving a PCB assembly having an impedance blocking filter circuit mounted thereon, a first filtered modular jack connectable to a telephone set, a second filtered modular jack connectable to an answering machine or fax machine, and a third unfiltered modular jack connectable to DSL or HPN equipment devices.

It is still another object of the present invention to provide a wall phone filter housing unit which includes slidable mounting means for facilitating easy and quick connection to a wall telephone mounting plate.

In accordance with a preferred embodiment of the present invention, there is provided a wall phone filter housing unit adapted for interfacing between incoming telephone lines connected to a wall telephone mounting plate and subscriber's network termination equipment. The housing unit includes a base member, a cover member adapted for co-mating with the base member, and a PCB assembly being disposed between the base member and the cover member. An impedance blocking filter circuit is mounted on the PCB assembly disposed between the base member and the cover member.

The housing unit further includes a first modular plug extending from a central portion of the base member for insertion into a modular jack connected to incoming telephone lines. A first filtered modular jack is mounted in a central portion of the cover member for receiving a second modular plug connected to a telephone set. A second filtered modular jack is formed upon one side of the PCB assembly for receiving a third modular plug connected to an answering machine or fax machine. A third unfiltered modular jack is formed upon another side of the PCB assembly for receiving a fourth modular plug connected to DSL or HPN equipment devices.

### BRIEF DESCRIPTION OF THE DRAWINGS

These and other objects and advantages of the present invention will become more fully apparent from the following detailed description when read in conjunction with the accompanying drawings with like reference numerals indicating corresponding parts throughout, wherein:

FIG. 1 is an exploded, perspective view of a component wall phone filter housing unit of the present invention which is adapted for interfacing between a wall telephone mounting plate and a wall phone;

FIG. 2 is a front, perspective view of the housing unit of FIG. 1;

FIG. 3 is a rear, perspective view of the housing unit of FIG. 1;

FIG. 4 is an exploded, perspective view of the housing unit of FIG. 2;

FIG. 5 is a front plan view of the front housing member of FIG. 4;

FIG. 6 is a rear plan view of the front housing member of FIG. 4;

FIG. 7 is a side elevational view of the front housing member, taken along the lines 7-7 of FIG. 5;

FIG. 8 is a cross-sectional view, taken along the lines 8-8 of FIG. 6;

FIG. 9 is a cross-sectional view, taken along the lines 9-9 of FIG. 6;

FIG. 10 is a front plan view of the rear housing member of FIG. 4;

FIG. 11 is a rear plan view of the rear housing member of FIG. 4;

FIG. 12 is a side elevational view taken along the lines 12-12 of FIG. 10;

FIG. 13 is a top plan view of the rear housing member, taken along the lines 13-13 of FIG. 10;

FIG. 14 is a cross-sectional view taken along the lines 14-14 of FIG. 11;

FIG. 15 is a cross-sectional view taken along the lines 15-15 of FIG. 11;

FIG. 16 is a front plan view of the PCB assembly of FIG. 4;

FIG. 17 is a schematic circuit diagram of the impedance blocking filter circuit mounted on the PCB assembly of FIG. 16;

FIG. 18 shows the wire connector assembly having its wire pin being bent upwardly, prior to the wave soldering process; and

FIG. 19 shows the wire connector assembly of FIG. 18, after the wave soldering process.

### DESCRIPTION OF THE PREFERRED EMBODIMENT

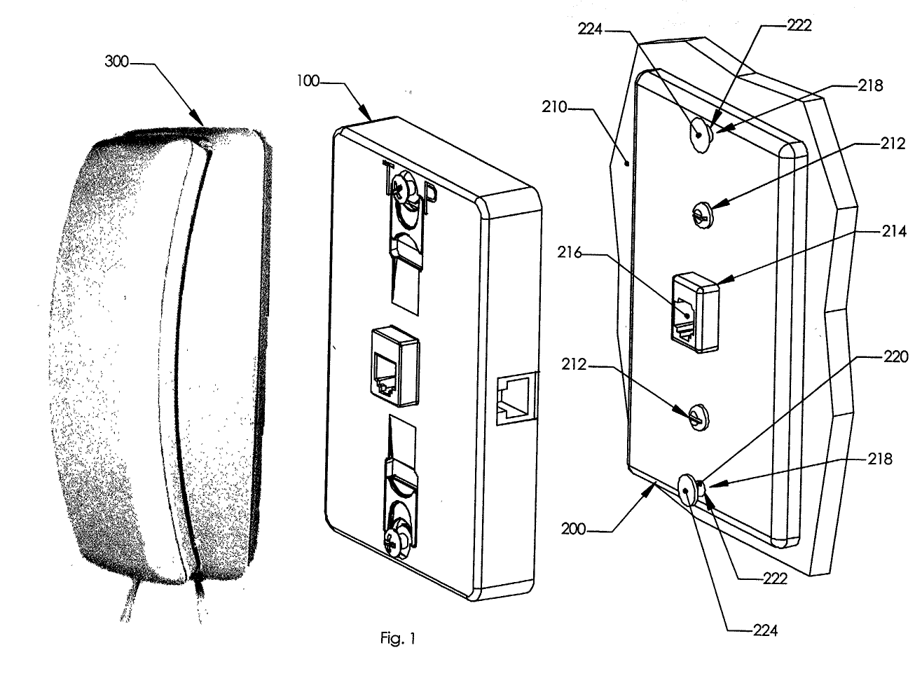

Referring now to the various views of the drawings, there is shown in FIGS. 1 through 4 a compact wall phone filter housing unit 100, constructed in accordance with the principles of the present invention, which is adapted for interfacing between a wall telephone mounting plate 200 and a conventional wall telephone 300. The filter housing unit 100 houses an impedance blocking filter circuit which serves to isolate all voice band equipment devices such as telephone sets (including cordless types), answering machines, facsimile (Fax) machines, 56 kb/s and lower rate modems, automatic dialers, and recorder connectors located at a subscriber's or customer's premises from the high-speed DSL (Digital Subscriber Line) and HPN (Home Phone Network) signals (data streams).

The wall telephone mounting plate 200 is adapted to be secured directly to a supporting wall 210 by typically screws 212. The mounting plate 200 includes a modular RJ-11 jack 214 located in its central portion and provided with a plug-receiving aperture 216. A pair of mounting posts 218 are disposed vertically in a spaced-apart relationship on opposite sides of the RJ-11 jack 214. Each of the mounting posts 218 in includes a post shank 220 formed between a collar 222 and a head 224 which serves as a support for the wall phone housing unit 100.

The wall housing unit 100 is adapted to be mounted to the wall mounting plate 200 and abuts against the front surface thereof. The wall unit 100 includes a RJ-11 plug 226 (FIG. 3) which is received within the aperture 216 of the wall mounting plate. In addition, the wall unit 100 is adapted to cooperate with the mounting post 218 and engages with the shank 220 of each mounting post 218 so as to secure the wall unit 100 in an upright position.

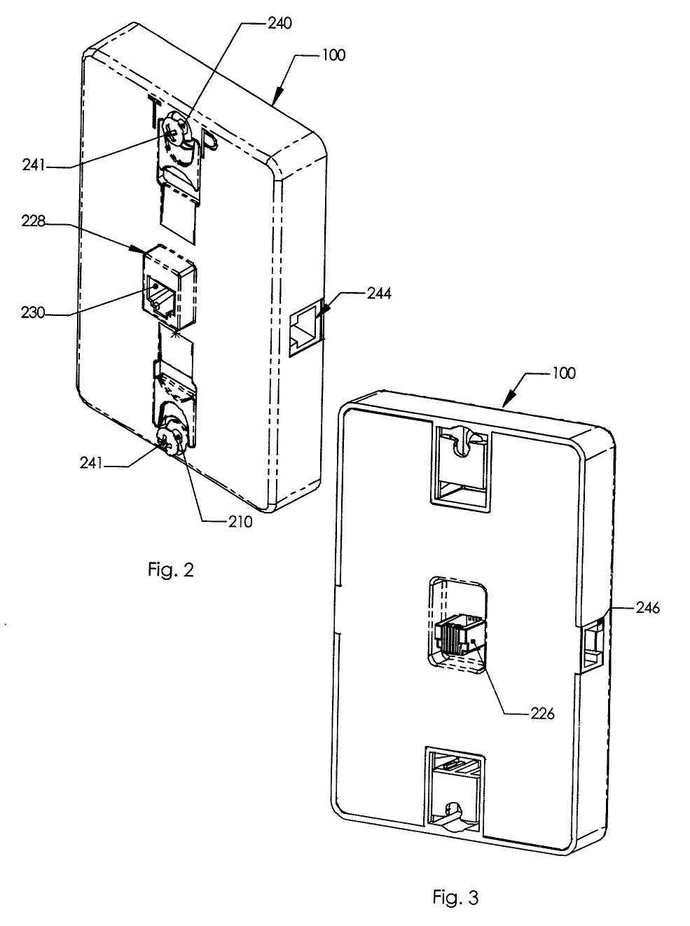

Further, the wall unit 100 includes a filtered RJ-11 jack 228 (FIG. 2) located in its central portion and provided with a plug-receiving aperture 230. A pair of mounting posts 232 is located in a vertically spaced-apart relationship to each other on opposite sides of the RJ-11 jack 228. Each of the mounting posts 232 includes a threaded end 234 and a head 236. A collar 238 is disposed between the threaded end 234 and the head 236 so as to define a shoulder which is tightened down and abuts the top surface on the front housing member of the wall unit 100. A post shank 240 is disposed between the collar 238 and the head 236 and functions as a support for the conventional wall telephone 300.

The head 236 has a screwdriver slot 241 which is used to screw the threaded end 234 of the mounting post 232 into openings 242 formed in the front housing member of the wall unit 100. A RJ-11 plug (not shown) on the back side of the wall phone 300 is moveable sufficiently so as to allow keyhole slots (also not shown) to slide over and contactly engage with the respective shanks 240 of the mounting post 232 when it is inserted into the jack 228. The wall phone is thereafter pulled downwardly so as to securely hold the same in place.

As can be seen from FIG. 2, the wall unit 100 further includes a second filtered RJ-11 modular jack 244 positioned on the right side thereof which is used for connection to an answering or facsimile (Fax) machine. The wall unit 100 houses the impedance blocking filter circuit which is used to filter both the wall phone connectable to the jack 228 and the answering or Fax machine connected to the jack 244. In FIG. 3, it will be noted that the wall unit 100 also includes a third unfiltered RJ-11 modular jack 246 positioned on the left side of FIG. 2 which is used for the DSL or HPN equipment devices. The third jack 246 is unfiltered on the line connected to the DSL or HPN connection.

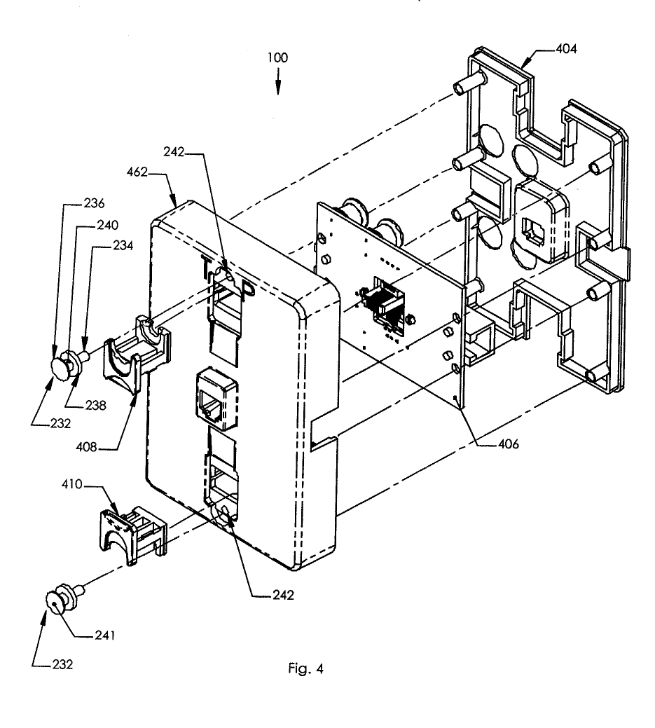

As can best be seen from FIG. 4, the wall filter housing unit 100 is comprised of a front or cover housing member 402, a rear or base housing member 404, and a PCB assembly 406 disposed between the cover member and the base member. An upper mounting latch 408 and a lower mounting latch 410 are insertable into the front housing member 402. The PCB assembly 406 is used for mounting the electrical components of the impedance blocking filter circuit as well as modular plugs and jacks.

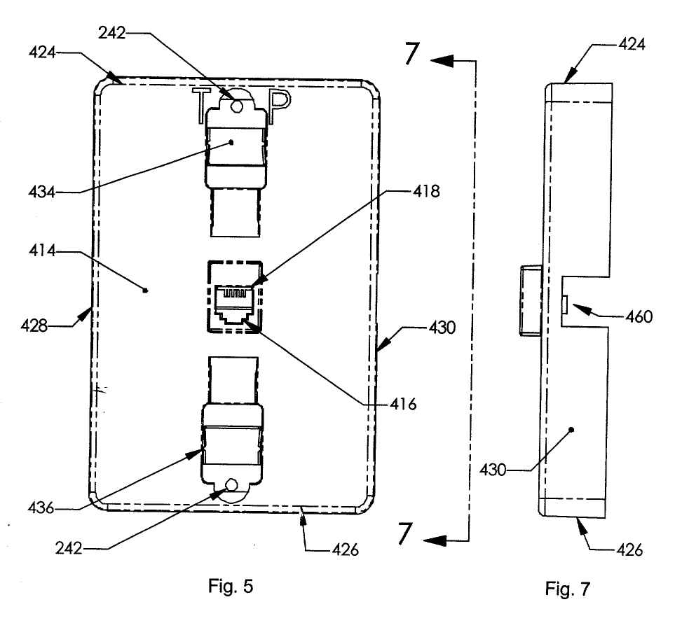

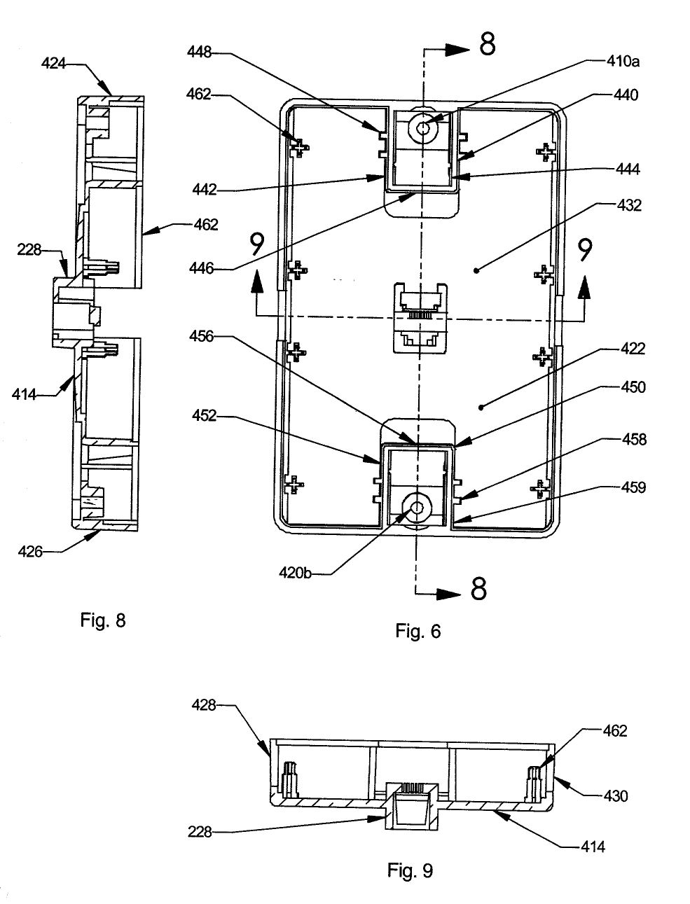

The cover member 402 shown generally in FIG. 4 and illustrated in more detail in FIGS. 5-9 will now be described. In particular, FIG. 5 shows a front plan view of the cover member 402 of FIG. 4, and FIG. 6 is a rear plan view of the cover member 402 of FIG. 4.

The front housing member 402 has an aperture 412 formed in a central location through which the RJ-11 wall phone jack 228 extends integrally from the top surface 414 thereof. The jack 228 has the footprint of a conventional RJ-11 communication jack which includes a plug-receiving aperture 416 and spring type conductor contacts 418. There are disposed vertically on opposite sides of the jack 228 and adjacent to the respective top and bottom edges of the cover member 402 the opening 242 for receiving the threaded ends 234 of the mounting post 232 so that the collar 238 lies substantially flush with the top surface 414. Further, the cover openings 242 are defined in small cylindrical members 420a, 420b which extend from the rear surface 422 of the cover member 402. The threaded ends 234 of the mounting post 232 are threaded into the respective openings 242 in the cylindrical members 420a, 420b.

The cover member 402 is molded from a suitable plastic material, such as ABS plastic and the like and is comprised of a top wall member 424, a bottom wall member 426, and confronting sidewall members 428, 430. All of the wall members are formed integrally with the rear surface 422 so as to define a cavity 432 for receiving and enclosing the PCB assembly 406. Below the cylindrical member 420a, there is provided a rectangularly-shaped opening 434 for receiving the upper mounting latch 408. Similarly, above the cylindrical member 420b there is provided a rectangularly-shaped opening 436 for receiving the lower mounting latch 410.

The cylindrical member 420a and the opening 434 are surrounded by a latch-receiving chamber 440 which is defined by opposed vertical wall members 442, 444 and a horizontal wall member 446 all integrally connected together. The vertical wall members 442, 444 are joined integrally to portions of the top wall member 424. Each of the wall members is formed with a pair of parallel, spaced apart rib members 448 which are receivable in recesses formed in the base member 404. The cylindrical member 420b and the opening 436 are surrounded by a latch-receiving chamber 450 which is defined by opposed vertical wall members 452, 454 and a horizontal member 456 all integrally connected together. Each of the wall members 452, 454 is joined integrally to portions of the bottom wall member 426. Each of the vertical wall members is formed with a pair of rib members 458 which are receivable in recesses formed in the base member 404.

Each of the sidewall members 428, 430 is formed in its middle portion with a U-shaped slot 460 for receiving the respective jacks 244, 246 (FIGS. 2 and 3). Further, the rear wall surface 422 of the cover member is provided with a plurality of retaining posts 462 disposed adjacent to the side edges thereof. The retaining posts 462 extend upwardly from the rear surface 422 and are adapted to mate with the retaining holes in the base member so as to secure and interlock the cover member 402 and the base member 404.

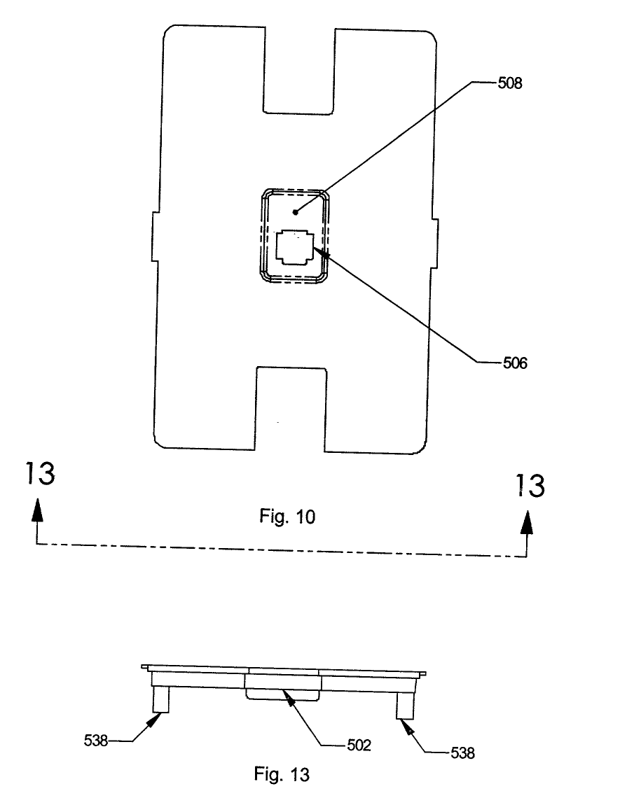

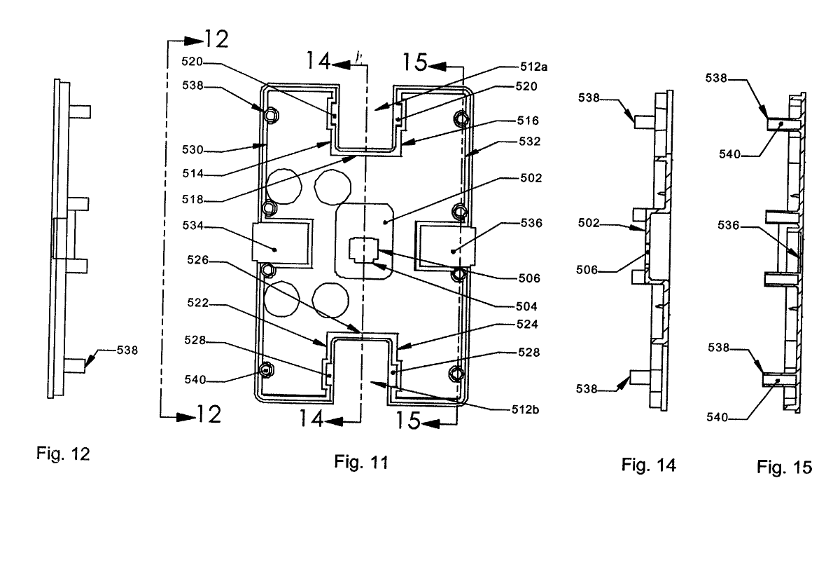

The base member 402 shown generally in FIG. 4 and depicted in full detail in FIGS. 10-14 will now be described. In particular, FIG. 10 is a front plan view of the base member 404 of FIG. 4, and FIG. 11 is a rear plan view of the base member 404 of FIG. 4. The rear housing member 404 has a central stepped portion 502 which is formed with an aperture 504 thereon. The aperture 504 is defined by two upstanding support members 506 and a depression 508 formed therebetween for engaging the modular plug 226 (FIG. 3).

There are disposed vertically on opposite sides of the stepped portion 502 and adjacent to the respective top and bottom edges of the base member, U-shaped cutouts 512a, 512b. The U-shaped cut-out 512a is circumscribed by vertical supporting ledges 514, 516 and a horizontal supporting ledge 518 all integrally formed together. Each of the vertical ledges 514, 516 is provided with a channel 520 for receiving the ribs 442 of the chamber 440. Similarly, the U-shaped cut-out 512b is circumscribed by vertical supporting ledges 522, 524 and a horizontal ledge 526 all integrally formed together. Each of the vertical ledges 522, 524 is provided with a channel 528 for receiving the ribs 458 of the chamber 450.

Further, there is disposed horizontally on opposite sides of the stepped portion 502 and adjacent to respective side edges 530, 532 of the base member 404, C-shaped cavities 534, 536 for receiving the respective modular jacks 246, 244. The internal wall surface 540 of the base member is provided with a plurality of tubular projections 538 having retaining holes 540 formed therein for co-mating with the retaining posts 462 of the cover member 402. The cover member 402 is also molded from a plastic material, such as ABS plastic and the like.

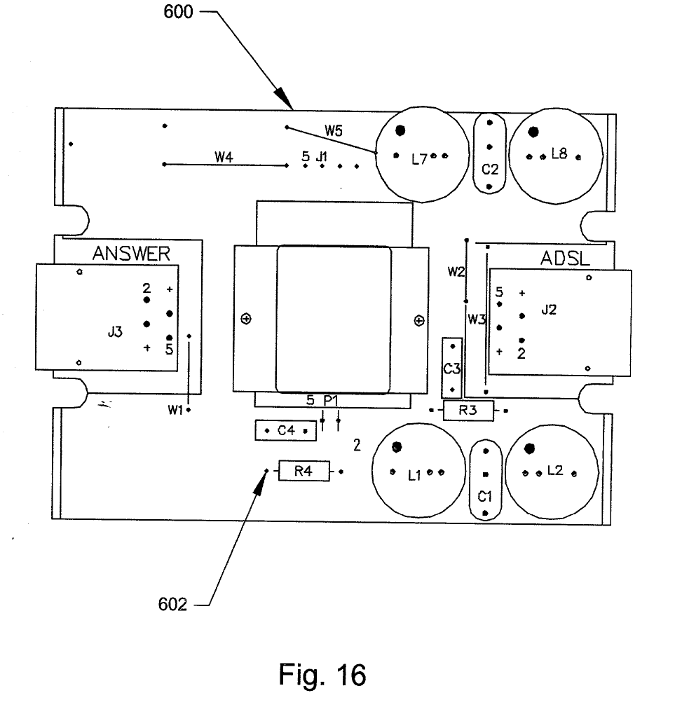

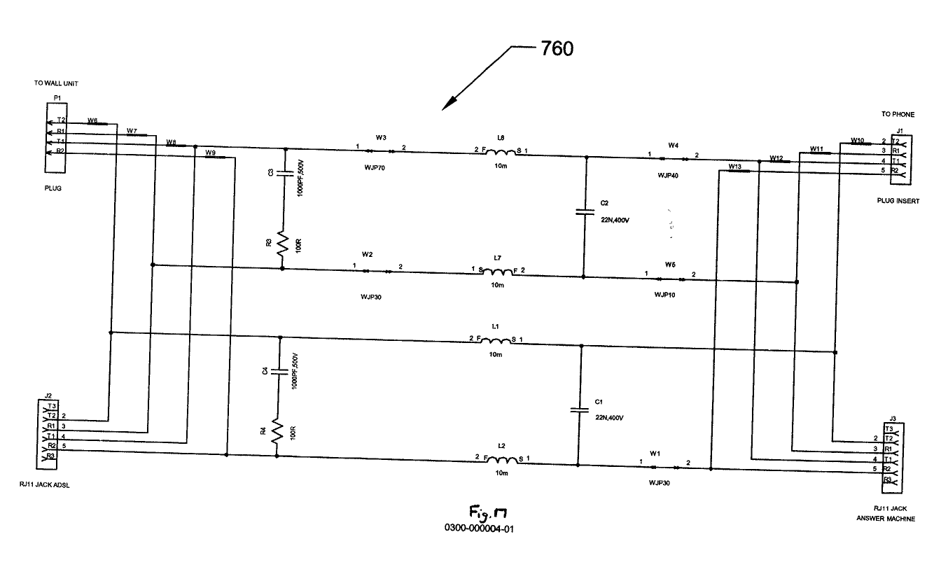

The PCB assembly 406 shown generally in FIG. 4 and depicted in a plan view in FIG. 16 will now be described. The PCB assembly 406 includes a printed circuit board 600 which is used to mount the electrical components of the impedance blocking filter circuit 700 depicted in the schematic circuit diagram of FIG. 17. The various circuit parts of the blocking filter circuit 700 are inserted into eyelets 602 formed in the printed circuit boards 600 and are preferably wave soldered thereto so as to securely mount the same thereon. It should be understood that other impedance filter circuits may be alternatively mounted on the printed circuit board. Such alternate blocking filter circuits are illustrated and described in U.S. Pat. No. 6,188,750 issued on Feb. 13, 2001, assigned to the same assignee as the present invention, which is hereby incorporated by reference in its entirety.

In assembly, all of the electrical components of the impedance blocking filter circuit 700 and the modular plugs and jacks are mounted on the printed circuit board 600 so as to form the PCB assembly 406 shown in FIGS. 4 and 16. This is typically performed in a separate assembly operation. The shoulder screws 232 and the mounting latches 408, 410 are mounted to the top surface of the cover member 402, as illustrated in FIG. 4. Next, the PCB assembly 406 is placed into the rear of the cover member 402 and is held therein by the retaining post 462. Then, the base member 404 is placed over the cover member 402 so that the retaining post 462 formed on the interior surface of the cover member 402 are received in the aligned holes 540 disposed on the interior surface of the base member 404, thereby sandwiching the PCB assembly 406 therebetween. The cover member and the base member are secured together by any conventional means of friction such as ultrasonic welding or the like so as to provide the wall phone filter housing unit 100 in its fully assembled condition, as depicted in FIGS. 2 and 3.

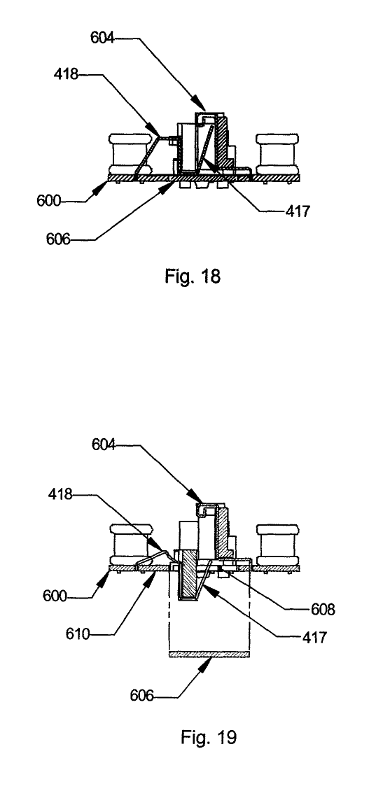

With reference now to FIGS. 18 and 19, there is illustrated the assembly operation for mounting the connector wire assembly 604 having the spring-type conductor contacts or wire pins 418 onto the printed circuit board 600 so as to prevent solder from contacting the wire pins during a wave soldering process. In FIG. 18, prior to the wave soldering there is shown a portion 417 of the wire pin 418 being bent upwardly into the connector wire assembly 604, which is designed to be initially not fully installed in the printed circuit board 600. A cut-out piece 606 of the printed circuit board 600, which was previously punched out, is reinstalled temporarily into the center hole 608 so as to protect the wire pins from the solder to be applied. Then, the wave soldering process is performed over the entire bottom side 610 of the printed circuit board 600 so as to securely mount all of the electrical components thereon.

In FIG. 19, after the wave soldering process, the connector wire assembly 604 is pushed down so as to fully seat against the top surface of the printed circuit board 600. As a result, the cut-out piece 606 will also be pushed out by a plug portion 612 so that the portion 417 of the wire pin 418 comes to rest below the bottom side 610 of the printed circuit board 600. The cut-out piece 606 is thereafter discarded.

In use, the plug of the conventional wall phone 300 is initially disconnected from the wall telephone mounting plate 200, and the wall phone filter housing 100 is connected instead to the mounting plate via the plug 226 extending to the base member 404. Then, the wall phone 300 is connected to the housing unit 100 via the telephone plug thereof. In order to facilitate installation of the housing unit to the mounting plate, the holes 434, 436 formed in the cover member are used to provide visual alignment of the upper and lower mounting latches 408, 410 with the mounting posts 218 formed on the mounting plate 200 (FIG. 1). In this manner, the mounting posts 218 can be easily received in the keyholes as the telephone plug in the back of the wall phone 300 is inserted into the central jack 216 of the mounting plate 200. Next, the housing unit 100 is slid downwardly so as to cause the upward latch 408 to slide upwardly and the lower latch to slide downwardly, thereby causing engagement and locking with the respective mounting posts 232. Finally, the plug on the wall phone is pushed into the jack 228 so as to make a connection.

From the foregoing detailed description, it can thus be seen that the present invention provides a compact wall phone filter housing unit which is adapted for interfacing between incoming telephone line connected to a wall telephone mounting plate and subscriber's or customer's network termination equipment. The wall phone filter housing unit includes a base member, a cover member adapted for co-mating with the base member, and a PCB assembly having an impedance blocking filter circuit mounted thereon disposed between the base member and the cover member. The wall phone filter housing includes upper and lower mounting latches so as to facilitate easy connection to a wall mounting plate.

While there has been illustrated and described what is at present considered to be a preferred embodiment of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiment disclosed as the best mode contemplated for carrying out the invention, but that the invention will include all embodiments falling within the scope of the appended claims.

What is claimed is:

1. A wall phone filter housing unit adapted for interfacing between incoming telephone lines connected to a wall mounting plate and subscriber's network termination equipment, said housing unit comprising:
a base member;
a cover member adapted for co-mating with said base member;
a PCB assembly being disposed between said base member and said cover member;
an impedance blocking filter circuit mounted on said PCB assembly disposed between said base member and said cover member;
a first modular plug extending from a central portion of said base member for insertion into a modular jack connected to incoming telephone lines;
a first filtered modular jack mounted in a central portion of said cover member for receiving a second modular plug connected to a telephone set;
a second filtered modular jack formed on one side of said PCB assembly for receiving a third modular plug connected to an answering machine or Fax machine; and
a third unfiltered modular jack formed upon another side of said PCB assembly for receiving a fourth modular plug connected to DSL or HPN equipment devices.

2. A wall phone filter housing unit as claimed in claim 1, wherein said filter housing unit is of a compact size.

3. A wall phone filter housing unit as claimed in claim 1, wherein each of said first through fourth modular plugs is comprised of a standard telephone RJ-type plug.

4. A wall phone filter housing unit as claimed in claim 3, wherein each of said first through third modular jacks is comprised of a standard telephone RJ-type jack.

5. A wall phone filter housing unit as claimed in claim 1, wherein said base member and said cover member are formed of a suitable plastic material.

6. A wall phone filter housing unit as claimed in claim 1, further comprising slidable mounting means for engaging and locking with mounting posts formed on the wall mounting plate.

7. A wall phone filter housing unit as claimed in claim 6, wherein said slidable mounting means includes an upper mounting latch and a lower mounting latch, each being slidable so as to engage and lock with the mounting posts formed on the wall mounting plate.

8. A wall phone filter housing unit as claimed in claim 1, wherein said cover member includes a top wall member, a bottom wall member, and confronting sidewall members all formed integrally with a rear surface so as to define a cavity for receiving and enclosing said PCB assembly.

10. A wall phone filter housing unit as claimed in claim 9, wherein said base member includes a central stepped portion which is formed with an aperture for engaging said first modular plug.

11. A wall phone filter housing unit adapted for interfacing between incoming telephone lines connected to a wall mounting plate and subscriber's network termination equipment, said housing unit comprising:
housing means formed of co-mating base and cover members;
component-mounting means disposed within said housing means for mounting an impedance blocking filter circuit;
plug means extending from said housing means for insertion into a modular jack connected to incoming telephone lines; and
jack means formed in said housing means for connection to a telephone set, an answering machine, and ADSL equipment.

12. A wall phone filter housing unit as claimed in claim 11, wherein said filter housing unit is of a compact size.

13. A wall phone filter housing unit as claimed in claim 11, wherein each of said first through fourth modular plugs is comprised of a standard telephone RJ-type plug.

14. A wall phone filter housing unit as claimed in claim 13, wherein each of said first through third modular jacks is comprised of a standard telephone RJ-type jack.

15. A wall phone filter housing unit as claimed in claim 11, wherein said base and cover members are formed of a suitable plastic material.

16. A wall phone filter housing unit adapted for interfacing between incoming telephone lines connected to a wall mounting plate and subscriber's network termination equipment, said housing unit comprising:
housing means formed of co-mating base and cover members;
component-mounting means disposed within said housing means for mounting an impedance blocking filter circuit;
plug means extending from said housing means for insertion into a modular jack connected to incoming telephone lines;
jack means formed in said housing means for connection to a telephone set, an answering machine, and ADSL equipment; and
slidable mounting means formed on said housing means for engaging and locking with mounting posts formed on the wall mounting plate.

17. A wall phone filter housing unit as claimed in claim 16, wherein said slidable mounting means includes an upper mounting latch and a lower mounting latch, each being slidable so as to engage and lock with the mounting posts formed on the wall mounting plate.

18. A wall phone filter housing unit as claimed in claim 1, further comprising means for protecting wire pins of a connector wire assembly mounted on said PCB assembly from solder during a wave soldering process.

19. A wall phone filter housing unit as claimed in claim 11, further comprising means for protecting wire pins of a connector wire assembly mounted on said component-mounting means from solder during a wave soldering process.

20. A wall phone filter housing unit as claimed in claim 16, further comprising means for protecting wire pins of a connector wire assembly mounted on said component-mounting means from solder during a wave soldering process.
